(19) United States
(12) Patent Application Publication
(10) Pub. No.: US 2026/0074546 A1
(43) Pub. Date: Mar. 12, 2026

(54) SYSTEMS AND METHODS FOR REGULATED BATTERY CHARGING

(71) Applicant: CALLISTO TECHNOLOGIES, LLC, Chesterfield, MO (US)

(72) Inventors: Samuel B. BAUMOHL, Chesterfield, MO (US); Diana W. BAUMOHL, Chesterfield, MO (US)

(21) Appl. No.: 19/105,248

(22) PCT Filed: Sep. 8, 2023
(86) PCT No.: PCT/US2023/032296

§ 371 Date: Feb. 20, 2025

Related U.S. Application Data
(60) Provisional application No. 63/405,247, filed on Sep. 9, 2022.

(51) Int. Cl. H02J 7/00

(52) U.S. Cl. CPC H02J 7/933; H02J 7/42; H02J 7/70; H02J 7/82; H02J 7/84

(57) ABSTRACT

A charging system is provided. The charging system includes a charging device including an electrical input for receiving electrical energy, at least one output for outputting electrical energy, and a communication interface; and a charger controller programmed to a) receive a plurality of charging parameters; b) determine a charging rate of an electronic device connected to the at least one output of the charging device; c) instruct the charging device to provide electrical energy through the output to the electronic device; d) determine a current state of charge of the electronic device; e) adjust the charging rate based on the current state of charge and the plurality of charging parameters; and f) instruct the charging device to adjust the charging rate for the electrical energy being provided to the electronic device.

### CROSS REFERENCE TO RELATED APPLICATIONS

This application claims the benefit of priority to U.S. Provisional Patent Application No. 63/405,247, filed on 9 Sep. 2022, which is hereby incorporated by reference in its entirety.

### BACKGROUND

The field of the disclosure relates generally to regulated battery charging, and more particularly, to systems and methods for controlling the amount of charge and timing of charge delivered into a battery for portable devices.

The majority of charging devices for small portable electronics, including mobile phones, tablets and the like, support users with the fastest possible charge to a target device prioritizing short-term convenience versus longer term battery and device life. The majority of these electronic devices have embedded lithium-ion batteries (LIBs) that a user either cannot replace or are prohibitively expensive to replace. Furthermore, there are variations in the performance of different charging cables and charging devices.

A battery has its internal components that store charge. In particular, the battery has an array, or particle lattice, that stores charge and then releases charge upon demand of a device connected thereto. Heat may break down the particle lattice overtime as excessive heat energizes particles and may loosen, stretch, or break the lattice. A broken lattice has less storage potential than a new battery. Furthermore, abrupt or instantaneous demand upon a battery also affects the lattice as a large charge flow partially empties the lattice and increases the polarity of the remaining charge in the lattice. In addition, many available tools do not allow the user to control the attributes of the charging process. Accordingly, there is a need to extend the recharging life of batteries such as those for electronic devices.

### BRIEF DESCRIPTION

In one aspect, a charging system is provided. The charging system includes a charging device including an electrical input for receiving electrical energy, at least one output for outputting electrical energy, and a communication interface; and a charger controller programmed to a) receive a plurality of charging parameters; b) determine a charging rate of an electronic device connected to the at least one output of the charging device; c) instruct the charging device to provide electrical energy through the output to the electronic device; d) determine a current state of charge of the electronic device; e) adjust the charging rate based on the current state of charge and the plurality of charging parameters; and f) instruct the charging device to adjust the charging rate for the electrical energy being provided to the electronic device. The system may direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 is a front view of an exemplary charger in accordance with at least one embodiment of the present disclosure.

FIG. 2 is a back view of the exemplary charger shown in FIG. 1.

FIG. 3 is a side view of the exemplary charger shown in FIG. 1.

FIG. 4 is another side view of the of the exemplary charger shown in FIG. 1.

FIG. 5 is a bottom view of the exemplary charger shown in FIG. 1.

FIG. 6 is a top view of the exemplary charger shown in FIG. 1.

FIG. 7 is a perspective view of the exemplary charger shown in FIG. 1.

FIG. 8 is a front view of an alternate exemplary charger in accordance with at least one embodiment of the present disclosure.

FIG. 9 is a back view of the alternate exemplary charger shown in FIG. 8.

FIG. 10 is a side view of the alternate exemplary charger shown in FIG. 8.

FIG. 11 is another side view of the alternate exemplary charger shown in FIG. 8.

FIG. 12 is a bottom view of the alternate exemplary charger shown in FIG. 8.

FIG. 13 is a top view of the alternate exemplary charger shown in FIG. 8.

FIG. 14 is a perspective view of the alternate exemplary charger shown in FIG. 8.

FIG. 15 illustrates a simplified block diagram of an exemplary computer system for monitoring and controlling a charging process in accordance with at least one embodiment of the present disclosure.

FIG. 16 illustrates an exemplary configuration of a client computer device shown in FIG. 15, in accordance with one embodiment of the present disclosure.

FIG. 17 illustrates an exemplary configuration of a server shown in FIG. 15, in accordance with one embodiment of the present disclosure.

FIG. 18 illustrates a flow chart of an exemplary computer implemented process for monitoring and charging electronic devices shown in FIG. 15 using the system shown in FIG. 15.

The Figures depict preferred embodiments for purposes of illustration only. One skilled in the art will readily recognize from the following discussion that alternative embodiments of the systems and methods illustrated herein may be employed without departing from the principles of the disclosure described herein.

### DETAILED DESCRIPTION

The present disclosure relates generally to regulated battery charging, and more particularly, to systems and methods for controlling the amount of charge and timing of charge delivered into a battery for portable devices.

Users, particularly those of mobile phones and portable devices, generally lack an understanding of how their devices work. In general, most users of portable electronics only know that something is wrong when their device does not perform the actions that they wish. Furthermore, many existing charging products primarily emphasize reaching maximum charge, i.e., fully charged, as fast as possible so that the device receiving the charge returns to function, fast.

Presently, lithium-ion batteries, or LIB, have the widest use as technology and materials for mobile device energy storage. Like other batteries, LIB begin to degrade over time due to repeated charging. The rate of degradation of LIB comes from environmental conditions and how users charge and use the devices that the LIB is housed in. Manufacturers of electronic devices do not provide consistent guidance and there currently are no industry standards in charging electronic devices. There can be a difference between what chargers put out in terms of electrical energy and what devices need to charge safely. Devices of different types may have different charging requirements. For example, a laptop has different charging requirements than a tablet or a smartphone, which have different charging requirements from each other. Furthermore, users may be unaware of these different charging requirements.

Accordingly, there are multiple different strategies for charging LIB and other battery devices. These strategies may include, but are not limited to, expediting to provide the fastest charge for the device, reduced charging rate to limit adverse effects on the battery, and/or charging to less than 100% to extend the life of the battery. The systems and methods described herein may be used to give the user the option to tradeoff between charging speed, final charge, and battery useful life.

Key use practices that affect the aging of LIB include:
1) the depth of discharge (DoD);
2) the state of charge (SoC), which refers to overcharging or over discharging LIB;
3) the current magnitude relative to battery size, that is, charge rate (RoC or C-Rate) referring to the charge transfer in and out of the battery or amp hour throughput; and.
4) the temperature of the battery.

In the exemplary embodiment, the system allows users to select state of charge (SoC) and charge rate (RoC or C-rate) parameters, features with standard charging cables, such as, but not limited to: two and three prong plugs; universal serial bus, or USB, and other appropriate options. The state of charge is monitored to avoid a pronounced low level of charge in a battery that prevents a battery from recharging. The state of charge is also used to manage charging to an optimal percentage of battery capacity, typically below 85%. Alternatively, state of charge may provide the depth of discharge, thus indicating how much of battery capacity is not available.

The present disclosure allows a user who has an electronic device with an internal battery to deliver power to target device and to regulate the inflow of electricity to the disclosure so that the battery has a rate of charge (RoC), or alternatively a charging rate (C-Rate), less than a maximum rate and not beyond a specified percentage of the maximum rate of charge. The rate of charge may be reduced by the present disclosure if the temperature of the battery exceeds a safe threshold. The present disclosure is configured to deliver electrical charge to the battery of the electronic device in a manner that reduces degradation of the battery and thus maximizes its useful life. However, the present disclosure allows the user to override what is best for maximum battery life for that particular battery, and charge a device faster, if desired and up to 100% charge, if a fully charged battery is sought.

The present disclosure regulates the flow of electrical charge into a charging device and thereby controls the rate of charge and the state of charge as determined by collecting information about the state of the battery's charge. More specifically, the present disclosure allows the user to set parameters for charging of devices, such as C-rate, maximum charge, etc. and to provide monitored attributes, such as state of charge and/or time to reach maximum charge. When the battery of the device reaches the specified maximum for state of charge, the disclosed system suspends delivery of charge to a battery in a device.

More specifically, a charging device (also known as a charger) is in communication with a remote computer device, such as a mobile device, through an application. The charging device is capable of charging one or more connected electronic devices. The charging device is also capable of detecting a current state of charge in the battery of each connected electronic device. In some embodiments, the charging device receives the state of charge information through a charging cable that connects the charger to the charger. In other embodiments, the charging device is in wireless communication with the device being charged. In some embodiments, the charger is modular and allows different outlets and/or charging ports to be added and/or removed from the modular charger.

In the exemplary embodiment, the charging device is capable of wirelessly connecting to a remote computer device, such as a user mobile device. The user mobile device is configured to execute an application, such as, but not limited to, a web application hosted on a webpage. The application allows the user to provide charging parameters to the charging device and to receive current charging status for one or more connected devices.

In at least one embodiment, the charging parameters include, but are not limited to, maximum state of charge, minimum state of charge, rate of charging (C-rate), and/or any time constraints. For the purposes of this discussion, the optimal minimum and maximum SoC range for LIB is between 20% and 80% charged. The charging rate can be provided as wattage, such as via the USB standards which are 5 W, 10 W, or 20 W and greater, for mobile phones, tablet computers, and personal computers. The suggested wattages may vary based on device, manufacturer, and other factors. Time constraints refer to any limitations that the user has on charging time. For example, the user may only have two hours to charge the device and the system provides as much charge as possible in that time frame. The time constraint may also be that the user is charging the device overnight, so the system may charge the device over a period of several hours and may charge until the user gets up at 7 AM, for example.

In a further embodiment, the system monitors and reports the rate of power consumption to provide to users. In at least one embodiment, the rate of electricity usage is provided at the beginning of a charging session and periodically thereafter to estimate the duration for each percentage change in SoC. The system then provides the user an estimate as to the total time to charge the connected device to the selected maximum state of charge and updates the time remaining to maximum state of charge for the user throughout the charging process.

The system is configured to optimize the charge delivered to an internal battery of a connected device based upon a selected max SoC and the time charge constraint. Once the maximum SoC is reached, the system ceases delivery of charge to the connected device. The system then indicates to the user that maximum charge has reached the battery of the connected device. The disclosure makes its second gauge blink to so indicate. The system controls charging to maximize and to optimize the life of a rechargeable battery in the connected electronic device. This contributes to reducing the degradation of a battery and thus lengthening the useful life of electronic devices having such batteries.

This system enables users of devices with rechargeable batteries to power their devices, to regulate the inflow of electrical charge so that the battery charges neither too fast and not beyond a specified percentage of the maximum, or 100%, charge. The system charges a battery of a user's device in a manner that lessens degradation of the battery, that is, its particle lattice and thus maximizes the life of the battery.

Inside of the application, the user is able to see the status of the connected charger, their current device SoC and RoC, and an estimated time to charge completion (if the charger is currently active). When the charger is connected, the user can set certain parameters which determine the charger's behavior. First, the user can set a maximum state-of-charge (Max SoC) to charge to, past which the charger will automatically shut itself off to avoid overcharging the battery. The application and/or charger controller will provide a warning as the electronic device approaches min SoC set by the user, at which point the charger will re-enable charging to reach max SoC to keep the battery within the desired SoC range. Second, a user can set a maximum rate-of-charge (Max RoC) from predetermined options for their electronic device. Additionally, the user can input a time at which they want their device to have charged itself to reach Max SoC. Each of these parameters is optional, and if the user does not input Max RoC or a desired time, the application and/or charger controller will calculate these parameters and display them to the user. Finally, the user can toggle the charger on or off entirely.

In the exemplary embodiment, the application and charger controller use Bluetooth Low Energy (BLE) technology to establish a connection with the charger when it is first connected. When using the charger for the first time, the application and charger controller provides an onboarding process which helps users pair the charger with their mobile computer device. Once the devices are paired, the charger will automatically connect to the user's device once it is plugged in.

During the charging process, the application and/or the charger controller will periodically send updates to the charger containing information about the device's current SoC. Additionally, if a user changes one of the parameters in the application, an update containing the new parameters will be sent to the microcontroller of the charger. If the communication with the charger is interrupted, the application will notify the user that charging will be shut off to protect their electronic device. The charger will also monitor the device's temperature during the charging process or the ambient temperature, if no device temperature is available, and will notify the user that the charging will be shut off to protect their device should the temperature fall outside of defined acceptable ranges.

In some further embodiments, the application 430 and/or charger controller only controls the rate of charge. In some additional embodiments, the application and/or charger controller may determine the drain rate of the battery, how much power the device is using at a given point in time, and the age and condition of the battery to assist with calculating the rate of charge and/or time until charge complete. In embodiments where these values are unknown or difficult to measure, the application and/or charger controller can give a reasonably varied range in the time estimate to complete charging. This may be done by establishing a baseline for different devices, such as from charging data for those devices over time.

When a user begins a charging session, the application and/or the charger controller reads the set parameters, and attempts to calculate a Max RoC and estimated time to completion, if the user has not already set those parameters themselves. If the user does not provide a time to completion, the application and/or the charger controller will use the provided RoC and Max SoC to calculate the time to completion. If the user does not provide a Max RoC, the application and/or charger controller will look at the desired time to completion and Max SoC and determine an appropriate Max RoC automatically. Periodically, the application and/or charger controller will check the current SoC of the electronic device, and may make adjustments to the ROC if the device will not reach the max SoC by the desired time. The application and/or charger controller sends these updates to the microcontroller, which adjusts the RoC. If the user does not provide any parameters, the electronic device will charge at the lowest Max RoC until the device reaches 80% by default.

FIGS. 1-14 illustrate two exemplary configurations for the charging device described herein. One having skill in the art would understand that other configurations may also be used with the systems and methods described herein to perform the features and functions described herein.

FIG. 1 is a front view of an exemplary charger 1 in accordance with at least one embodiment of the present disclosure. Charger A as shown in FIG. 1 includes an elongated power strip 2, which acts as an interface device as described herein. Power strip 2 includes a housing 3 that holds at least one outlet 4 and at least one USB socket 5 for connecting devices to charge. Power strip 2 is configured to provide electrical energy through the at least one outlet 4 and the at least one USB socket 5 to connected devices. The USB socket 5 may include any type of USB or charging port, such as, but not limited to, USB Type A, USB Type B, USB Type C, USB Mini B, USB Micro B, USB 3.0 Type A, USB 3.0 Type B, USB 3.0 Micro B, and/or lightning connector.

The power strip 2 also includes a first visible gauge 6, where the first visible gauge 6 defines the state of charge (SoC) parameters, such as the percentage of charge currently in the corresponding connected device that is connected to the corresponding outlet 4 or USB socket 5. A second visible gauge 7 configured to display a specified minimum parameter and a specified maximum parameter for the state of charge of the corresponding connected device that is connected to the corresponding outlet 4 or USB socket 5. A timer 8 with a readout of at least two characters display the amount of time in minutes until the charge of an attached device reaches the specified maximum parameters. While first visible gauge 6, second visible gauge 7, and time 8 appear to be LED (light emitting diode) numerical displays, one having skill in the art would understand that other displays may be used to display information to the user. These may include, but are not limited to, LED indicator lights, OLED (organic light-emitting diode) screen, LCD (liquid crystal display) screen, and/or any other type of display to provide the information to the user. The connected device may be an electronic device, such as a mobile phone, a tablet computer, and the like.

Outwardly from the second timer 8, the strip 2 has a surge protector 40 generally centered upon an end of the strip 2 and a cord 41 extending outwardly through the protector 40. The cord 41 has a desirable length such as between three to eight feet where the length may be limited from power loss. Opposite the protector 40, the cord 41 ends with a plug 42. The plug 42 connects the strip 2 to a source of electrical charge, such as a wall outlet with utility service, a generator, a line from solar power, a battery pack, an electric vehicle, and/or any available power source. In some further embodiments, the charger A includes a battery for holding charge to provide through the outlets 4 or USB sockets 5.

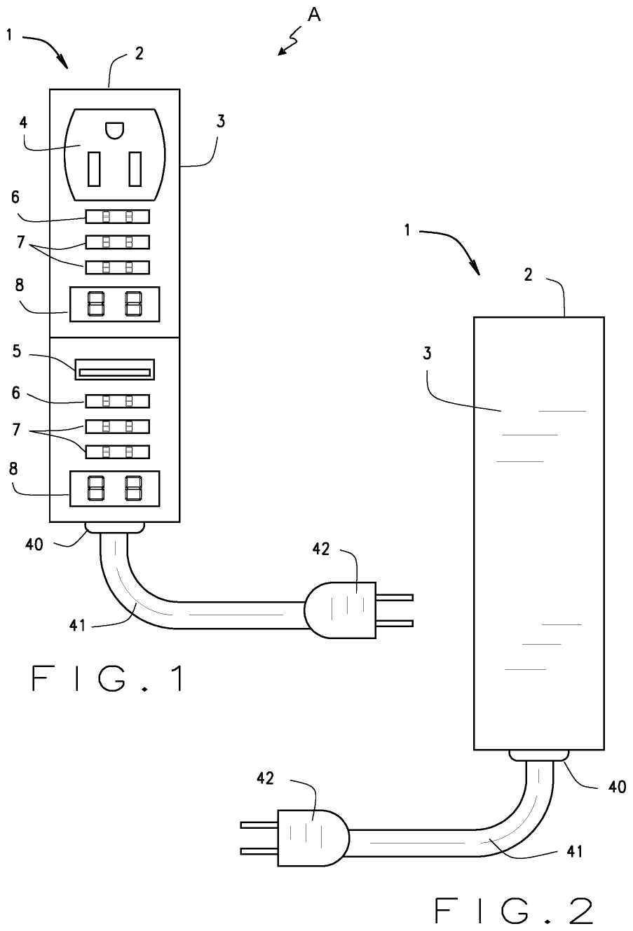

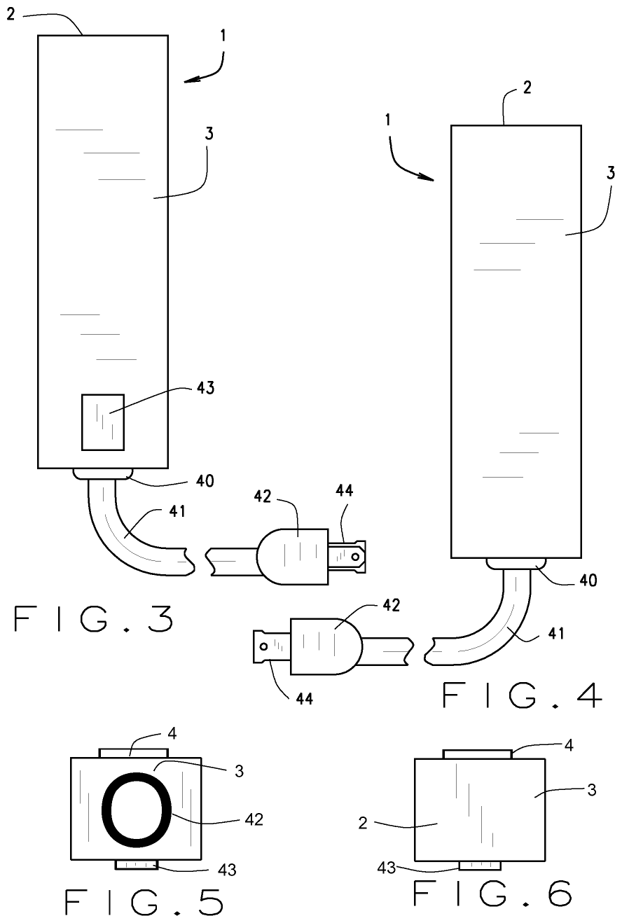

FIG. 2 is a back view of the exemplary charger A (shown in FIG. 1). FIG. 3 is a side view of the exemplary charger A (shown in FIG. 1). FIG. 4 is another side view of the of the exemplary charger (shown in FIG. 1).

The housing 3 has its side as shown here with a switch 43 towards the end with the protector 40 that leads to the cord 41 and the plug 42. The switch 43 allows a user to admit electrical current into the strip 2 of the or to stop electrical current entering the strip 2. The plug 42 includes one or more prongs 44 for connecting to an outlet for electrical power. FIGS. 3 and 4 show another prong 44 of the plug 42 of a slightly different shape. In the preferred embodiment, the plug 42 has polarized prongs 44 and thus the plug 42 connects in only one way to an outlet. Additionally, plug 42 may include a grounded prong (not shown) as well.

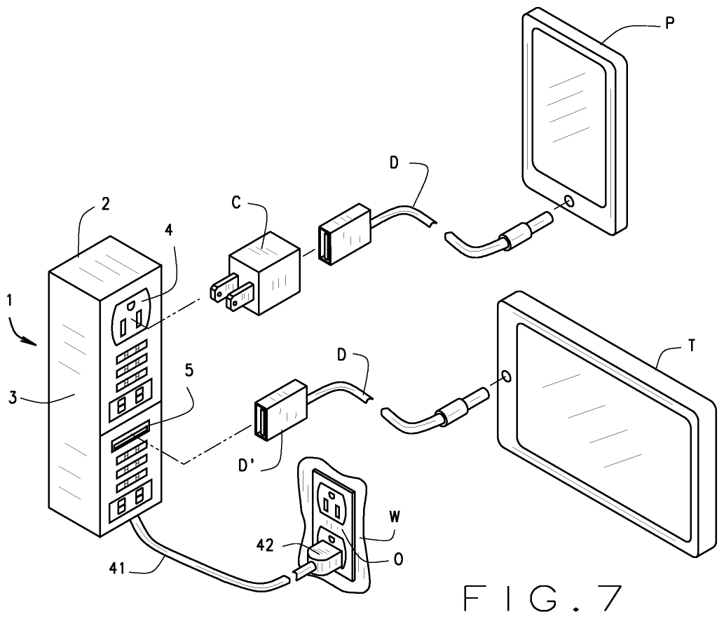

FIG. 5 is a bottom view of the exemplary charger A (shown in FIG. 1). FIG. 6 is a top view of the exemplary charger A (shown in FIG. 1).

FIG. 7 is a perspective view of the exemplary charger shown in FIG. 1. FIG. 7 shows a perspective view of the charger A with the strip 2 deployed for usage. The strip 2 has its cord 41 extended and its plug 42 having its prongs 44 inserted into an existing outlet O in a wall W, as in a residential or an office setting. The strip's outlet 4 then receives a charging cube C, or USB adapter 5, that connects with a charging cable D usually with a USB end and an opposite fitted end. The fitted end then connects with an electronic device such as a mobile phone P. Also, the strip's USB socket 5 connects with a charging cable D usually with a USB end as at D′ and an opposite fitted end. The fitted end here then connects to another electronic device such as a tablet computer T or mobile phone P. In some embodiments, the fitted end is a specialized connector. In other embodiments, the fitted end is a charging port, such as, but not limited to, USB Type A, USB Type B, USB Type C, USB Mini B, USB Micro B, USB 3.0 Type A, USB 3.0 Type B, USB 3.0 Micro B, lightning connector, and/or any other desired connector.

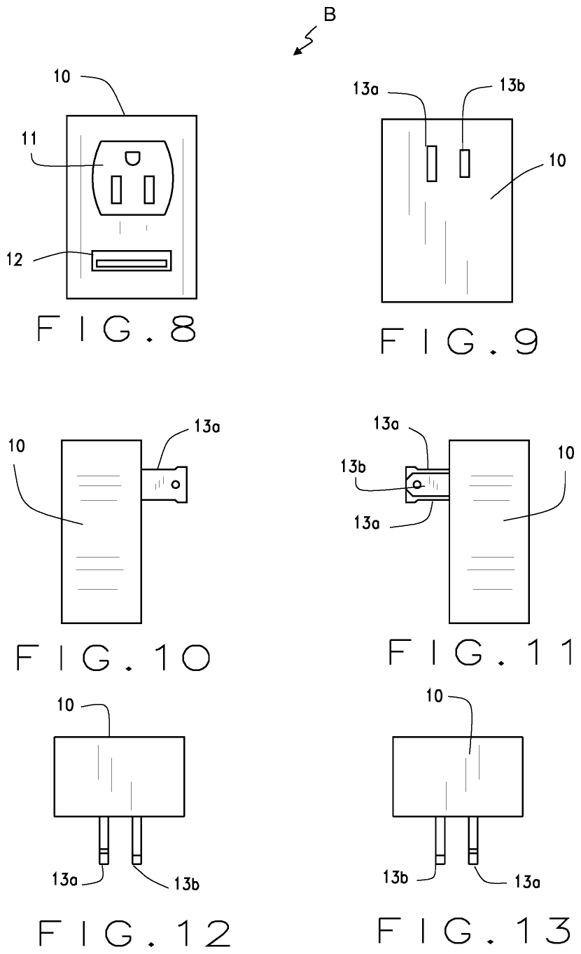

FIG. 8 is a front view of an alternate exemplary block charger B in accordance with at least one embodiment of the present disclosure. Exemplary block charger B is a shortened charger when compared to charger A (shown in FIG. 1). Block charger B includes a housing 10 in a block form that contains an outlet 11 and a USB style charging port 12. These are similar to outlet 4 and USB port 5 (both shown in FIG. 1), respectively. Block charger B is configured to provide electrical energy through the at least one outlet 11 and the at least one USB socket 12 to connected devices. The USB socket 12 may include any type of USB or charging port, such as, but not limited to, USB Type A, USB Type B, USB Type C, USB Mini B, USB Micro B, USB 3.0 Type A, USB 3.0 Type B, USB 3.0 Micro B, and/or lightning connector.

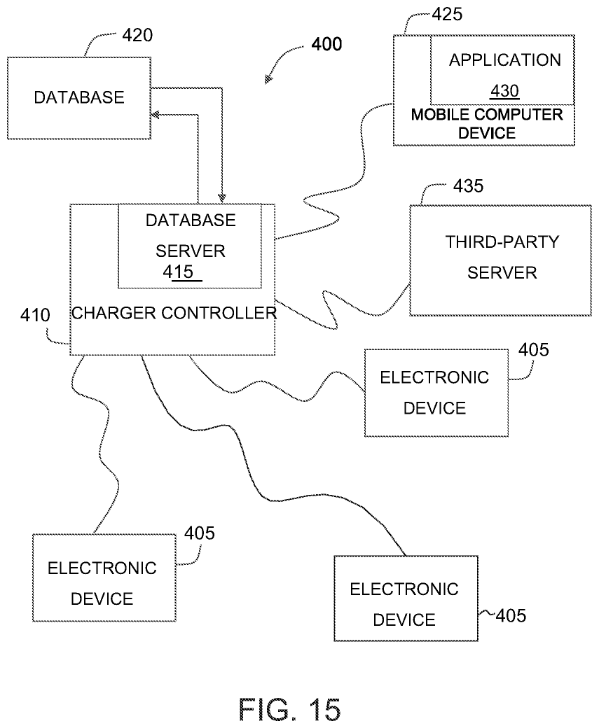

In some embodiments, the charger A or B is modular and allows different outlets 4 and/or charging ports 5 to be added and/or removed from the modular charger. The additional modules are configured to be electrically connected to the rest of the charger A or B to provide charge to the connected electronic devices. Furthermore, the additional modules are in communication with the charger controller 410 (shown in FIG. 15) to control the amount of charge provided by the added outlet 4 and/or charging port 5.

FIG. 9 is a back view of the alternate exemplary charger B (shown in FIG. 8). FIG. 10 is a side view of the alternate exemplary charger B (shown in FIG. 8). FIG. 11 is another side view of the alternate exemplary charger B (shown in FIG. 8). FIG. 12 is a bottom view of the alternate exemplary charger B (shown in FIG. 8). FIG. 13 is a top view of the alternate exemplary charger B (shown in FIG. 8). These various views show that block charger B was configured to be directly connect to an outlet O, rather than having a cord 41 (shown in FIG. 1). More specifically, block charger B includes at least two prongs 13a and 13b for connecting to an outlet O for electrical power. Prongs 13a and 13b are shown to be a slightly different shape. In the preferred embodiment, these are polarized prongs 13a and 13b and thus the prongs 13a and 13b connects in only one way to an outlet O. Additionally, a grounded prong (not shown) may be included as well.

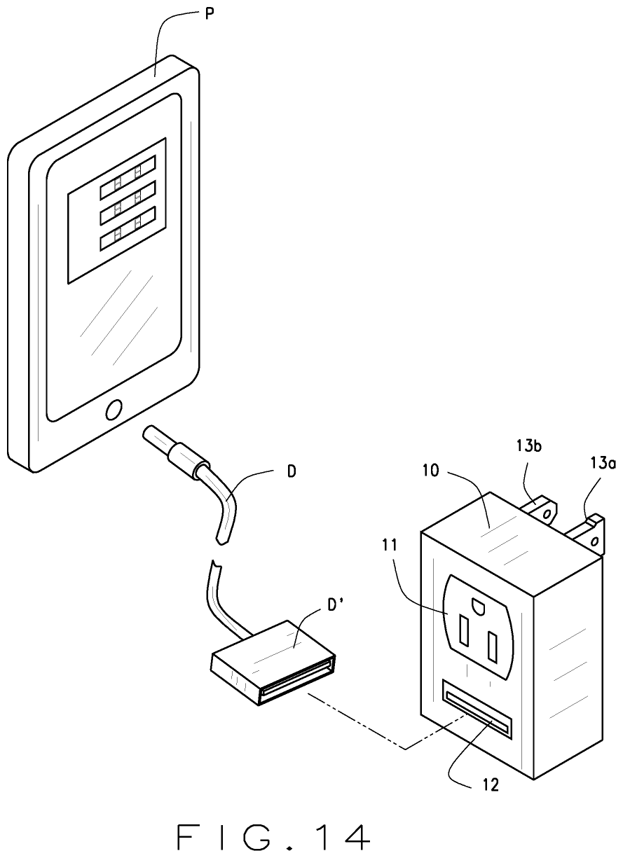

FIG. 14 is a perspective view of the alternate exemplary charger B (shown in FIG. 8). FIG. 14 describes a perspective view of the block charger B with the block form deployed for usage towards the right. Block charger B has its housing 10 with the prongs 13a, 13b extended to the right towards an existing outlet O, not shown, as in a residential or an office setting. The block's outlet 11 may receive a charging cube or other adapter, not shown, for an existing charging cable. Here in this figure though, the block's USB socket 12 receives a charging cable D with its USB end as at D′ inserting into the socket 12 and an opposite fitted end. The fitted end then connects to another electronic device such as a mobile phone P. In some embodiments, the fitted end is a specialized connector. In other embodiments, the fitted end is a charging port, such as, but not limited to, USB Type A, USB Type B, USB Type C, USB Mini B, USB Micro B, USB 3.0 Type A, USB 3.0 Type B, USB 3.0 Micro B, and/or lightning connector.

Charger A and Charger B also include a wireless connection (not shown). The wireless connections allow the chargers 1 and 9 to communicate with remote computer devices to provide charging information about the connected devices and to receive parameters for charging those devices. Some examples of the wireless connection include, but are not limited to, Wi-Fi, Bluetooth, NFC (Near Field Communication), and/or any other wireless system that allows the system to work as described herein.

FIG. 15 depicts a simplified block diagram of an exemplary computer system 400 for monitoring and controlling a charging process in accordance with at least one embodiment of the present disclosure. In the exemplary embodiment, system 400 may be used for controlling the charging of electronic devices 405. In the exemplary embodiment, the charging of the electronic devices 405 is through a charger A and B (shown in FIGS. 1 and 8), which provides throttled electrical current to the connected electronic devices 405 to charge the battery(s) of those devices.

In the exemplary embodiment, the system 400 is configured to provide an alternative solution for users who prioritize lengthening battery life and therefore extending the useful life of a given device over the fastest possible (daily) charge to reach a maximum charge state. In other embodiments, the system 400 may be configured to charge electronic devices 405 at various different speeds, which may or may not be the fastest charging speed available for the electronic device 405.

The system 400 provides users of portable electronic devices with the ability to control the rate of charge (RoC) and limit the state of charge (SoC) within a specified range in order to lengthen the useful life of the LIB. This system 400 prolongs battery life in electronic devices 405 such as cell phones, tablets, laptops or remotely managed devices or other devices that rely on LIBs. System 400 determines the rate of charge (C-Rate) by type of device or size of device. System 400 also allows the user to provide a time to charge parameter and will then calculate the lowest RoC to reach the desired max SoC in the time specified. The system 400 calculates the estimated time to reach target SoC by incorporating information from the electronic device 405 about the amount of power the target device is consuming. System 400 also monitors the temperature of the electronic device 405. In at least one embodiment, the system 400 defaults to a “no degradation” RoC based upon an electronic device type or size input, unless overridden by the user.

In the exemplary embodiment, electronic devices 405 are powered by rechargeable batteries, such as, but not limited to, including lead-acid, zinc-air, nickel-cadmium (NiCd), nickel-metal hydride (NiMH), lithium-ion (Li-ion), lithium iron phosphate (LiFePO4), lithium-ion polymer (Li-ion polymer), and any other rechargeable battery. In the exemplary embodiment, electronic devices 405 electrically connect to the charger A or B via a wired or wireless connection to receive charge from the charger A and B. In some embodiments, the electronic devices 405 are in communication with the charger controller 410 via a wired connection, such as the wired connection for receiving electrical charge. In other embodiments, the electronic devices 405 are in communication with the charger controller 410 via a wireless connection, such as, but not limited to, Wi-Fi, Bluetooth, NFC, etc. Examples of electronic devices 405 include, but are not limited to, a laptop computer, a personal digital assistant (PDA), a cellular phone, a smartphone, a tablet, a phablet, wearable electronics, smart watch, earbuds, electronic toys, a power bank, power tools, an electric vehicle, and/or other electronic, battery-powered devices.

In at least one embodiment, the charger controller 410 is a part of charger A and B. In other embodiments, charger controller 410 is in communication with the charger A and B. The charger controller 410 throttles typical US electrical utility current delivered at a wall outlet through resistance and impedance. In the exemplary embodiment, charger controller 410 is a computer allows remote computer devices, such as, but not limited to electronic device 405 and mobile computer device 425 to connect using a web browser or a software application, which enables electronic device 405 and/or mobile computer device 425 to access the charger controller 410 using the Internet or other network. More specifically, charger controller 410 is communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Charger controller 410 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. The charger controller 410 may be remote from the charger A and B and cloud-based or the charger controller 410 may be located at the charger A and B.

A database server 415 may be communicatively coupled to a database 420 that stores data. In one embodiment, database 420 may include battery profiles, charging parameters, and/or user preferences. In the exemplary embodiment, database 420 may be stored remotely from charger controller 410. In some embodiments, database 420 may be decentralized. In the exemplary embodiment, a user may access database 420 via user computer devices 425 by logging onto charger controller 410, as described herein.

Mobile computer devices 425 may also execute an application 430. Mobile computer devices 425 may be configured to execute application to receive data from charger controller 410 and transmit data to charger controller 410. Mobile computer device 425 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Mobile computer device 425 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In some embodiments, mobile computer device 425 is configured to execute application 430 to communicate with charger controller 410. In these embodiments, the application 430 receives charging status information from the charger controller 410 and provides charging parameters to the charger controller 410.

In the exemplary embodiment, third-party servers 435 are computers that include a web browser or a software application, which enables third-party servers 435 to access charger controller 410 using the Internet or other network. More specifically, third-party servers 435 are communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Third-Party servers 450 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. The third-party servers 435 may be remote from the charger A and B and/or remote from the charger controller 410. In the exemplary embodiment, the third-party server 435 provides data about different devices and charging information about the lifecycle of different batteries.

A further embodiment of the disclosure has two primary components: 1) the above-described charger A and B that delivers and regulates the charge delivered to connected electronic devices, and 2) a software application 430, typically installed upon a mobile computer device 425, as a mobile app or accessible via a webpage as a webapp. In these embodiments, the application 430 is able to communicate with the charger A and B via the charger controller 410. In some embodiments, the charger controller 410 is a part of the charger A and B. In other embodiments, the charger controller 410 is remoted from the charger A and B, such as in the cloud.

In the further embodiments, the charger A and B provides electrical power to electronic devices 405 simultaneously and receives its control from the application 430, often on the user's mobile computer device 425, such as, but not limited to, a mobile phone, tablet computer, or personal computer. Within the application 430, the user defines SoC and C-rate parameters and obtains the status of the charger A and B and any electronic devices 405 connected to it. The application communicates with the charger A and B wirelessly, such as via Wi-Fi, Bluetooth, NFC, or another wireless standard. The charger A and B described above accepts a plug with prongs, a USB interface, other charging port interfaces, and a wireless charging interface. The charger A and B also connects to an electrical power outlet.

In at least one embodiment, the application 430 interfaces with the charger controller 410 to control the charger A and B using a constant connection, which may be wired or wireless. The charger controller 410 makes continual adjustments to the C-Rate and total amount of charge to an optimal C-Rate/amount for the device under charge, particularly its battery. In some other embodiments, the application 430 is installed on the electronic device 405. In still further embodiments, the application 430 is installed within the battery itself and this installation provides information about the battery's SoC. For the software resident in the battery or an electronic device 405 powered by a battery, the software pairs readily with a user's mobile device 425. The software coordinates with the wireless antenna and related circuity of a user's mobile computer device 425. The software is configured to have robust programming with a wide database 420 of battery and electronic device 405 profiles.

In some embodiments, the charger controller 410 regulates delivery of charge into a battery, preferably during periods of low electric grid usage, e.g., midnight to 6 AM local time of the electronic device 405. The charger controller 410 also detects excessive, abrupt, or near instantaneous large draws of charge from a battery. The charger controller 410 then sends an alert message to a user, via SMS, onscreen notification, push notification, onboard LED/gauges, and the like. If a user does not act timely, the charger controller 410 then disables at least one existing mobile phone app committing an excessive, abrupt, or near instantaneous large draw of charge from the battery.

In an alternate embodiment, the charger controller 410 collects as much information as possible as to the specifications of that battery under charge, plus continual snapshots of the state of charge and rate of charge. Towards this objective, if information does not appear from a direct scan of the battery, the charger controller 410 allows the user to enter the model number and other information about the electronic device 405 with a battery under charge or the battery undercharge itself. The method then compares that electronic device 405 or battery data to a database 420 about different batteries and devices. The charger controller 410 may also contact third-party servers 435, such as those associated with manufacturers The charger controller 410 compares the entered data to known data about that battery. The charger controller 410 approximates the optimal battery charging protocol and assesses the health of the battery.

The above system 400 may be used in multiple different manners to provide charging power to these electronic devices 405. In the first embodiment, the system 400 is configured for a wired plug-in device.

For a wired plug-in device in one embodiment, the system 400 allows the user to set the rate of charge (RoC) by the size of the device. In this embodiment, the application 430 allows the user to select a size of the electronic device 405 for the desired rate of charge (i.e., small, medium, or large). The user may also directly select the desired rate of charge value. In this embodiment, the user enters the current state of charge (SoC) value into the application 430. Based upon inputs, the charger controller 410 estimates total charge time and communicates the total charge time to the application 430 to display to the user.

In another embodiment for the wired plug-in device, the system 400 allows the user to input the parameters. In this embodiment, the application 430 allows the user to select the desired rate of charge. In this embodiment, the user enters the current state of charge (SoC) value into the application 430. The user also inputs the maximum desired charge. The charger A or B begins power delivery to the electronic device 405. After a time interval, the application 430 prompts user to enter the current SoC. Based upon the original and new SoC, the charger controller 410 estimates time to charge for the electronic device 405 to reach the maximum desired charge. The charger controller 410 communicates the total charge time to the application 430 to display to the user.

In a further embodiment for the wired plug-in device, the system allows the user to select the rate of charge for Lithium-ion batteries. In Lithium-ion batteries, the rate of charge slows at the battery approaches full (e.g., 100% charged). In this embodiment, the application 430 allows the user to select the desired rate of charge. The user also inputs the maximum desired charge. The charger A or B begins power delivery to the electronic device 405. The charger controller 410 monitors the rate of charge for the electronic device and stops providing power once a decline in the ROC is detected.

For a wired plug-in device in yet another embodiment, the system 400 allows the user to charge by type of device. In this embodiment, the application 430 allows the user to select a type of the electronic device 405 for the desired rate of charge (i.e., mobile phone, tablet, or laptop). In this embodiment, the user enters a percentage charge to add to the electronic device 405, effectively setting a maximum charge for the electronic device 405. The charger A or B begins power delivery to the electronic device 405 based upon the device type and desired percentage charge.

In yet a further embodiment, the charger controller 410 receives a total available time to charge (e.g., the user has eight hours to charge the electronic device 405). The charger controller 410 instructs/controls the charger A and B to deliver charge at lowest optimal RoC over a longer period of time. This over-rides the initial RoC setting.

In another embodiment, the electronic device 405 is wired into the charger A and B and the electronic device 405 also includes an application. In this embodiment, the electronic device 405 includes all transformer and protection capabilities inside device.

The Application 430 and/or charger controller 410 are designed to run on either a mobile or PC platform, and manages the connection between a user's device and the charger A and B. The Application 430 and/or charger controller 410 allows a user to control the charging of their electronic device 405 in several different ways. Various statistics of the user's device, including the state-of-charge (SoC) and rate-of-charge (RoC), are communicated from the Application 430 and/or charger controller 410 to the charger A and B. These statistics allow the charger A and B to adjust its status to meet the charging parameters set by the user. Furthermore, the Application 430 and/or charger controller 410 are designed to run in the background while the user's electronic device 405 is connected to the charger A and B, in order to continuously send updates to the charger A and B. Additionally, the Application 430 and/or charger controller 410 are capable of calculating and providing estimates to users about parameters such as time to charge completion.

The application 430 provides charging parameters from the user to the charger controller 410 and provides attributes of the electronic device 405 being charged to the user. The attributes include information about the health and status of the battery and/or the electronic device 405. The information may include, but is not limited to, current battery charge, maximum battery charge, maximum potential battery charge, maximum charging rate for electronic device, minimum charging rate for electronic device, time to maximum battery charge, battery temperature, and/or other information. In some embodiments, some of this information may be provided via indicators, (i.e., first visible gauge 6, second visible gauge 7, and/or timer 8 (all shown in FIG. 1).

The system 400 is informed by a database 420 of popular target devices with battery capacity (mAh) and recommended max RoC and min and max SoC. The Application 430 and/or charger controller 410 will use this database 420 to provide estimates of time to complete charging for a given electronic device 405 as well as to set optimal RoC and max SoC.

If an electronic device 405 temperature reading is available, the Application 430 and/or charger controller 410 will monitor this information and provide warnings and turn off or throttle charging (decrease RoC) until electronic device 405 returns to be within acceptable temperature range. In some embodiments, the temperature may be monitored from the mobile computer device 425, such as via ambient temperature.

Inside of the application 430, the user is able to see the status of the connected charger A and B, their current device SoC and RoC, and an estimated time to charge completion (if the charger A and B is currently active). When the charger A and B is connected, the user can set certain parameters which determine the charger's behavior. First, the user can set a maximum state-of-charge (Max SoC) to charge to, past which the charger A and B will automatically shut itself off to avoid overcharging the battery. The application 430 and/or charger controller 410 will provide a warning as the electronic device 405 approaches min SoC set by the user, at which point the charger A and B will re-enable charging to reach max SoC to keep the battery within the desired SoC range. Second, a user can set a maximum rate-of-charge (Max RoC) from predetermined options for their electronic device 405. Additionally, the user can input a time at which they want their device 405 to have charged itself to reach Max SoC. Each of these parameters is optional, and if the user does not input Max RoC or a desired time, the application 430 and/or charger controller 410 will calculate these parameters and display them to the user. Finally, the user can toggle the charger A and B on or off entirely.

In at least one embodiment, the charger A and B contains a pre-programmed microcontroller which is capable of adjusting the powered-on status and RoC of the charger A and B. The microcontroller establishes a wireless connection or can be used via a wired connection with the user's device 425 which allows it to receive periodic updates from the device 405.

When the charger A and B receives the signal from the user's device 425 to begin the charging process, it first reads the user-set parameters Max ROC, Max SoC, and desired time to completion, and saves these parameters in non-volatile memory. The microcontroller enables the charger A and B at the specified Max RoC and continues to wait for updates from the user's device 425. The charger A and B has the ability to incorporate load on the electronic device 405 (target burn rate) into time to charge calculation. Once the device 405 reaches max SoC, the charger A and B will turn off, but periodically will check the target device SoC. If the SoC falls below a minimum (min SoC), the charger A and B will be re-enabled and will recharge the electronic device 405 up to max SoC. If the charger A and B does not receive an update from the user's device or the electronic device 405 within five minutes, the charger A and B will automatically shut itself off to protect the electronic device 405.

In the exemplary embodiment, the application 430 and charger controller 410 use Bluetooth Low Energy (BLE) technology to establish a connection with the charger A and B when it is first connected. When using the charger A and B for the first time, the application 430 and charger controller 410 provides an onboarding process which helps users pair the charger A and B with their mobile computer device 425. Once the devices 425 are paired, the charger A and B will automatically connect to the user's device 425 once it is plugged in.

During the charging process, the application 430 and/or the charger controller 410 will periodically send updates to the charger A and B containing information about the device's current SoC. Additionally, if a user changes one of the parameters in the application 430, an update containing the new parameters will be sent to the microcontroller of the charger A and B. If the communication with the charger A and B is interrupted, the application 430 will notify the user that charging will be shut off to protect their electronic device 405. The charger will also monitor the device's temperature during the charging process or the ambient temperature, if no device temperature is available, and will notify the user that the charging will be shut off to protect their device should the temperature fall outside of defined acceptable ranges.

When a user begins a charging session, the application 430 and/or the charger controller 410 reads the set parameters, and attempts to calculate a Max RoC and estimated time to completion, if the user has not already set those parameters themselves. If the user does not provide a time to completion, the application 430 and/or the charger controller 410 will use the provided RoC and Max SoC to calculate the time to completion. If the user does not provide a Max RoC, the application 430 and/or charger controller 410 will look at the desired time to completion and Max SoC and determine an appropriate Max RoC automatically. Periodically, the application 430 and/or charger controller 410 will check the current SoC of the electronic device 405, and may make adjustments to the RoC if the device 405 will not reach the max SoC by the desired time. The application 430 and/or charger controller 410 sends these updates to the microcontroller, which adjusts the RoC. If the user does not provide any parameters, the electronic device 405 will charge at the lowest Max RoC until the device 405 reaches 80% by default.

In some further embodiments, the application 430 and/or charger controller 410 only controls the rate of charge. In some additional embodiments, the application 430 and/or charger controller 410 may determine the drain rate of the battery, how much power the device is using at a given point in time, and the age and condition of the battery to assist with calculating the rate of charge and/or time until charge complete. In embodiments where these values are unknown or difficult to measure, the application 430 and/or charger controller 410 can give a reasonably varied range in the time estimate to complete charging. This may be done by establishing a baseline for different devices, such as from charging data for those devices over time.

Some manufacturers provide more information than others about the battery of their electronic device. This can limit the reliability of the estimates made by the application 430 and/or charger controller 410. For example, for some manufacturers, the application 430 and/or charger controller 410 cannot measure drain rate of battery and/or the age of battery. Furthermore, some manufacturers will not notify the application 430 and/or charger controller 410 when the phone stops charging due to bad conditions, e.g., water in the charging port or over temperature conditions.

In some embodiments, the charger A and B is configured to have default behavior for situations where the application 430 and/or charger controller 410 is not running in the background and/or cannot connect to the application 430 and/or charger controller 410. In some embodiments, the user may use the application 430 and/or charger controller 410 to set-up the parameters and press an execute button so that the charger A and B follows the programmed parameters until told otherwise, even when the application 430 and/or charger controller 410 is out of communication. In these use cases, users might expect their phone to charge only to 80%, but if the charger A and B disconnects and doesn't know the electronic device's state of charge, the electronic device 405 might charge up to 100%. The charger A and B then has to rely on the time estimate without communication from the electronic device 405 about its state of charge.

Since it is easy for a user to accidentally close the application 430 on their mobile computer device 425, the application 430 is configured to notify the user and prompt them to keep the application 430 open while charging. If the user is using their mobile computer device 425 while it is being charged, then the application 430 needs to inform the charger controller 410 and/or the charger A and B of the state of charge due to the drain from the user's usage of the mobile computer device 425 during charging.

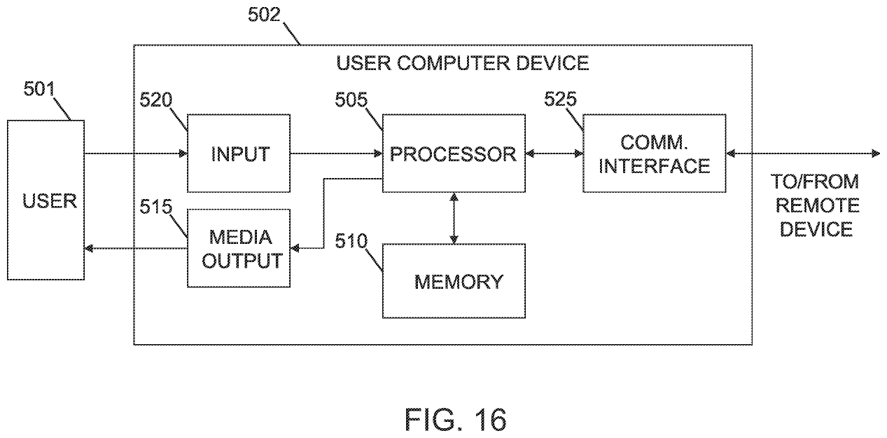

FIG. 16 depicts an exemplary configuration of mobile computer device 425 shown in FIG. 15, in accordance with one embodiment of the present disclosure. User computer device 502 may be operated by a user 501. User computer device 502 may include, but is not limited to, mobile computer devices 425, electronic device 405, charger controller 410 (all shown in FIG. 15), charger A, and charger B (both shown in FIG. 1). User computer device 502 may include a processor 505 for executing instructions. In some embodiments, executable instructions are stored in a memory area 510. Processor 505 may include one or more processing units (e.g., in a multi-core configuration). Memory area 510 may be any device allowing information such as executable instructions and/or transaction data to be stored and retrieved. Memory area 510 may include one or more computer readable media.

User computer device 502 may also include at least one media output component 515 for presenting information to user 501. Media output component 515 may be any component capable of conveying information to user 501. In some embodiments, media output component 515 may include an output adapter (not shown) such as a video adapter and/or an audio adapter. An output adapter may be operatively coupled to processor 505 and operatively couplable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 515 may be configured to present a graphical user interface (e.g., a web browser and/or a client application) to user 501. A graphical user interface may include, for example, an interface for displaying charging status. In some embodiments, user computer device 502 may include an input device 520 for receiving input from user 501. User 501 may use input device 520 to, without limitation, provide charging parameters.

Input device 520 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 515 and input device 520.

User computer device 502 may also include a communication interface 525, communicatively coupled to a remote device such as charger controller 410. Communication interface 525 may include, for example, a wired or wireless network adapter and/or a wireless data transceiver for use with a mobile telecommunications network.

Stored in memory area 510 are, for example, computer readable instructions for providing a user interface to user 501 via media output component 515 and, optionally, receiving and processing input from input device 520. A user interface may include, among other possibilities, a web browser and/or a client application. Web browsers enable users, such as user 501, to display and interact with media and other information typically embedded on a web page or a website from charger controller 410. A client application allows user 501 to interact with, for example, charger controller 410. For example, instructions may be stored by a cloud service, and the output of the execution of the instructions sent to the media output component 515.

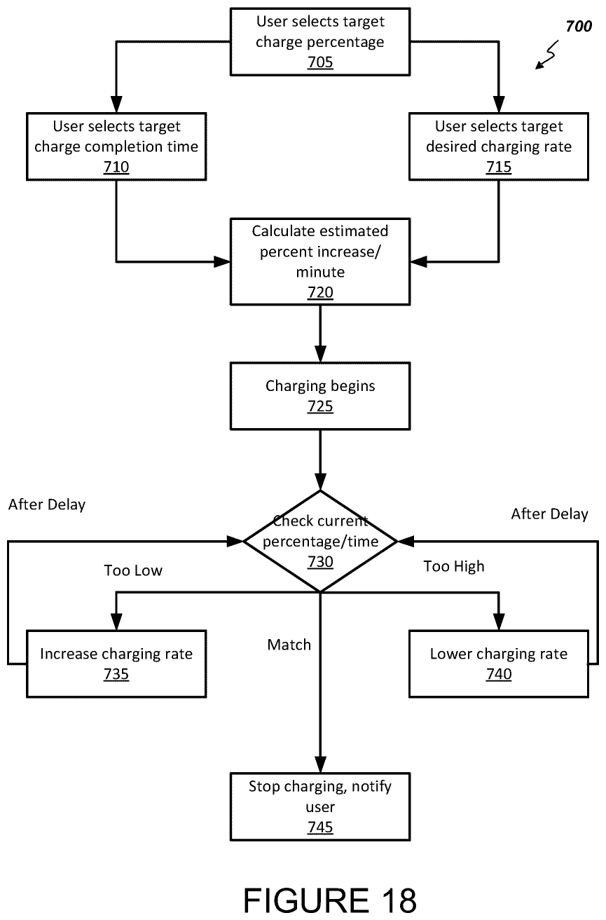

Processor 505 executes computer-executable instructions for implementing aspects of the disclosure. In some embodiments, the processor 505 is transformed into a special purpose microprocessor by executing computer-executable instructions or by otherwise being programmed. For example, the processor 505 may be programmed with the instruction such as illustrated in FIG. 18.

In some embodiments, user computer device 502 may include, or be in communication with, one or more applications, such as application 430 (shown in FIG. 15). User computer device 502 may be configured to receive data from the one or more sensors and store the received data in memory area 510. Furthermore, user computer device 502 may be configured to transmit the sensor data to a remote computer device, such as charger controller 410, through communication interface 525.

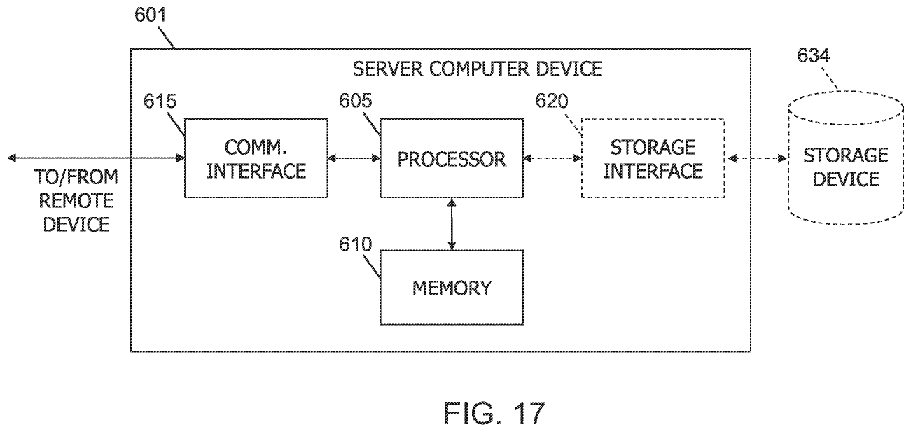

FIG. 17 depicts an exemplary configuration of a server 435 (shown in FIG. 15), in accordance with one embodiment of the present disclosure. Server computer device 601 may include, but is not limited to, database server 415, charger controller 410, and third-party server 435 (all shown in FIG. 15). Server computer device 601 may also include a processor 605 for executing instructions. Instructions may be stored in a memory area 610. Processor 605 may include one or more processing units (e.g., in a multi-core configuration).

Processor 605 may be operatively coupled to a communication interface 615 such that server computer device 601 is capable of communicating with a remote device such as another server computer device 601, electronic device 405 (shown in FIG. 15), mobile computer device 425 (shown in FIG. 15), charger A (shown in FIG. 1), charger B (shown in FIG. 8), and charger controller 410. For example, communication interface 615 may receive requests from mobile computer devices 425 via the Internet, as illustrated in FIG. 15.

Processor 605 may also be operatively coupled to a storage device 634. Storage device 634 may be any computer-operated hardware suitable for storing and/or retrieving data, such as, but not limited to, data associated with database 420 (shown in FIG. 15). In some embodiments, storage device 634 may be integrated in server computer device 601. For example, server computer device 601 may include one or more hard disk drives as storage device 634.

In other embodiments, storage device 634 may be external to server computer device 601 and may be accessed by a plurality of server computer devices 601. For example, storage device 634 may include a storage area network (SAN), a network attached storage (NAS) system, and/or multiple storage units such as hard disks and/or solid-state disks in a redundant array of inexpensive disks (RAID) configuration.

In some embodiments, processor 605 may be operatively coupled to storage device 634 via a storage interface 620. Storage interface 620 may be any component capable of providing processor 605 with access to storage device 634. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 634.

Processor 605 may execute computer-executable instructions for implementing aspects of the disclosure. In some embodiments, the processor 605 may be transformed into a special purpose microprocessor by executing computer-executable instructions or by otherwise being programmed. For example, the processor 605 may be programmed with the instruction such as illustrated in FIG. 18.

FIG. 18 illustrates a flow chart of an exemplary computer implemented process 700 for monitoring and charging electronic devices 405 (shown in FIG. 15) using the system 400 (shown in FIG. 15). Process 700 may be implemented by a computing device, for example charger controller 410 (shown in FIG. 15). In the exemplary embodiment, charger controller 410 may be in communication with a mobile computer device 425 (shown in FIG. 15), one or more electronic devices 405, charger A (FIG. 1), and/or charger B (FIG. 8).

In the exemplary embodiment, the user uses the application 430 and/or the charger controller 410 to select 705 a target charge percentage for an electronic device 405 (shown in FIG. 15). In some embodiments, the user selects 705 a maximum charge and a minimum charge percentage.

In some embodiments, the user selects 710 a target charge completion time for when the charging should be complete. This may occur when the user goes to sleep, and the target charge completion time is when the user's alarm is set to wake them up.

In other embodiments, the user selects 715 a target desired charging rate. The user may select a charging rate in watts. The user may also select by the size and/or type of the device, where each size and/or type of device has a different corresponding charging rate. The user may also select the specific device profile, from a saved profile of electronic devices 405.

The application 430 and/or the charger controller 410 calculates 720 an estimated percent increase of charger per minute based on the selected parameters. The application 430 and/or charger controller 410 communicates that percent increase of charge per minute and other parameters to the charger A and B, which then begins 725 charging.

After a period of time, the application 430 and/or charger controller 410 checks 730 the current percentage of charge or time to completion of charge for the electronic device 405. In some embodiments, the application 430 and/or charger controller 410 is in communication with the electronic device 405 being charged and is able to retrieve the current state of charge for the electronic device 405. In other embodiments, the charger A and B is able to determine the current state of charge for the electronic device 405. If the current percentage of charge or time to completion of charge for the electronic device 405, is too low (aka the device 405 will not complete charging in time), then the charger A and B increases its charging rate. If the current percentage of charge or time to completion of charge for the electronic device 405, is too high (aka the device 405 will complete charging significantly before time), then the charger A and B decreases its charging rate. The application 430 and/or charger controller 410 rechecks 730 the current percentage of charge or time to completion of charge for the electronic device 405 on a periodic basis.

If the electronic device 405 has reached the target percentage of charge and/or the completion time, the charger A and B stops 745 charging. The application 430 and/or charger controller 410 may then notify the user.

At least one of the technical problems addressed by this system may include: (i) lessens battery degradation; (ii) extends battery life; (iii) reduces energy cost; (iv) conserves electrical power; (v) provides optimal battery life; (vi) enables the collection of data to optimize charging over time; (vii) tailors charging speed to device being charged; and/or (viii) provide the user with a wide variety of charging options in an integrated device.

The methods and systems described herein may be implemented using computer programming or engineering techniques including computer software, firmware, hardware, or any combination or subset thereof, wherein the technical effects may be achieved by performing at least one of the following steps: a) receive a plurality of charging parameters; b) determine a charging rate of an electronic device connected to the at least one output of the charging device; c) instruct the charging device to provide electrical energy through the output to the electronic device; d) determine a current state of charge of the electronic device; e) adjust the charging rate based on the current state of charge and the plurality of charging parameters; f) instruct the charging device to adjust the charging rate for the electrical energy being provided to the electronic device; g) wherein the charger controller is housed in a housing of the charging device; h) wherein the charger controller is in communication with the charging device via a wireless connection; i) wherein the charger controller receives the plurality of charging parameters from a user via a mobile computer device; j) wherein an application on the mobile computer device interfaces between the user and the charger controller; k) wherein an output of the at least one output is an outlet; l) wherein an output of the at least one output is an USB connector; m) wherein an output of the at least one output is a lightning connector; n) wherein charger controller receives the current state of charge of the electronic device wirelessly from the electronic device; o) wherein an application on the electronic device transmits the current state of charge of the electronic device wirelessly from the electronic device; p) wherein charger controller receives the current state of charge of the electronic device through a wired connection with the electronic device; q) wherein charger controller receives the current state of charge of the electronic device wirelessly from the electronic device; r) wherein the user selects a desired rate of charge for the charger controller; s) wherein the user selects a device size for the charging rate; t) wherein the user selects a device type for the charging rate; u) wherein the plurality of charging parameters includes a maximum charge; v) wherein the maximum charge is less than 100%; w) wherein the plurality of charging parameters include a maximum charge of 80% and a minimum charge of 20%; x) wherein the charging device is configured to be plugging into a wall outlet; y) wherein the charging device is lightweight and portable; and/or wherein the application provides a plurality of attributes of charging the electronic device and the health and status of the battery to the user.

### ADDITIONAL CONSIDERATIONS

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; and Microsoft is a registered trademark of Microsoft Corporation, Redmond, Washington.)

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further example, the system is run on Android® OS (Android is a registered trademark of Google, Inc. of Mountain View, CA). In another example, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional examples that also incorporate the recited features. Further, to the extent that terms “includes,” “including,” “has,” “contains,” and variants thereof are used herein, such terms are intended to be inclusive in a manner similar to the term “comprises” as an open transition word without precluding any additional or other elements.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The patent claims at the end of this document are not intended to be construed under 35 U.S. C. § 112(f) unless traditional means-plus-function language is expressly recited, such as “means for” or “step for” language being expressly recited in the claim(s).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A charging system comprising:
a charging device including an electrical input for receiving electrical energy, at least one output for outputting electrical energy, and a communication interface; and
a charger controller including at least one processor in communication with at least one memory device and in communication with the charging device, wherein the at least one processor is programmed to:
receive a plurality of charging parameters;
determine a charging rate of an electronic device connected to the at least one output of the charging device;
instruct the charging device to provide electrical energy through the output to the electronic device;
determine a current state of charge of the electronic device;
adjust the charging rate based on the current state of charge and the plurality of charging parameters; and
instruct the charging device to adjust the charging rate for the electrical energy being provided to the electronic device.

2. The charging system of claim 1, wherein the charger controller is housed in a housing of the charging device.

3. The charging system of claim 1, wherein the charger controller is in communication with the charging device via a wireless connection.

4. The charging system of claim 1, wherein the charger controller receives the plurality of charging parameters from a user via a mobile computer device.

5. The charging system of claim 4, wherein an application on the mobile computer device interfaces between the user and the charger controller.

6. The charging system of claim 5, wherein the application provides a plurality of attributes of charging the electronic device and health and status of one or more batteries of the electronic device to the user.

7. The charging system of claim 1, wherein an output of the at least one output is an outlet.

8. The charging system of claim 1, wherein an output of the at least one output is an USB connector.

9. The charging system of claim 1, wherein an output of the at least one output is a lightning connector.

10. (canceled)

11. The charging system of claim 1, wherein an application on the electronic device transmits the current state of charge of the electronic device wirelessly from the electronic device.

12. The charging system of claim 1, wherein charger controller receives the current state of charge of the electronic device through a wired connection with the electronic device.

13. The charging system of claim 1, wherein charger controller receives the current state of charge of the electronic device wirelessly from the electronic device.

14. The charging system of claim 1, wherein a user selects a desired rate of charge for the charger controller.

15. The charging system of claim 1, wherein the user selects a device size for the charging rate.

16. The charging system of claim 1, wherein the user selects a device type for the charging rate.

17. The charging system of claim 1, wherein the plurality of charging parameters includes a maximum charge.

18. The charging system of claim 16, wherein the maximum charge is less than 100%.

19. The charging system of claim 1, wherein the charging device is configured to be plugged into a wall outlet.

20. The charging system of claim 1, wherein the charging device is lightweight and portable.

21. A method for charging implemented by a charger controller including at least one processor in communication with at least one memory device and in communication with a charging device, wherein the method comprises:
receiving a plurality of charging parameters;
determining a charging rate of an electronic device connected to at least one output of the charging device;
instructing the charging device to provide electrical energy through the output to the electronic device;
determining a current state of charge of the electronic device;
adjusting the charging rate based on the current state of charge and the plurality of charging parameters; and
instructing the charging device to adjust the charging rate for the electrical energy being provided to the electronic device.

22. A charger controller including at least one processor in communication with at least one memory device and in communication with a charging device, wherein the at least one processor is programmed to:
receive a plurality of charging parameters;
determine a charging rate of an electronic device connected to at least one output of the charging device;
instruct the charging device to provide electrical energy through the output to the electronic device;
determine a current state of charge of the electronic device;
adjust the charging rate based on the current state of charge and the plurality of charging parameters; and
instruct the charging device to adjust the charging rate for the electrical energy being provided to the electronic device.
